(19) United States
(12) Patent Application Publication
(10) Pub. No.: US 2005/0056382 A1
(43) Pub. Date: Mar. 17, 2005

(54) Window blinds with rotating slats that have different faces

(76) Inventor: Sassan Khajavi, Los Angeles, CA (US)

Correspondence Address: Sassan Khajavi, #202, 1377 S. Beverly Glen Blvd., Los Angeles, CA, 90024, US

(21) Appl. No.: 10/883,280

(22) Filed: Jun. 30, 2004

Related U.S. Application Data
(60) Provisional application No. 60/483,063, filed on Jun. 30, 2003.

(51) Int. Cl. E06B 9/26

(52) U.S. Cl. 160/167 R

(57) ABSTRACT

A vertical or horizontal window or skylight blind or shutter having slats which have two physically different surfaces on each face. The blinds overlap slightly at their long edges when closed, yet they are able to rotate at least 180 degrees around their longitudinal axis. One face of the slat has triangular grooves on it running parallel to the length of the slat. The triangular grooves are coated with a pigment that reflects by specular and/or direct diffusion the sun's electromagnetic energy, whereby the room is kept cool in summer and warm in winter.

This application claims the benefit of U.S. Provisional Patent Application 60/483,063 filed Jun. 30, 2003

### FIELD OF INVENTION

In 1996 a new blind invention with mirrored v-grooved slats on one of its slat surfaces was developed with a grant from the U.S. Department of Energy. In 1997 the blind was tested at the Lawrence Berkeley Labs to measure its energy-savings in hot weather. Tests were conducted over a two-week period in a LBL testing facility in Reno, Nev. This location was chosen by LBL because of high temperature differences in summer and winter as well as in day and night. The facility makes 381 physical, chemical, and thermal measurements every five minutes and logged on a computer. The test resulted were a success showing half the energy of the sun or 75 watts of heat per square meter of glass being reflected out.

However because of three drawbacks the project did not move forward:
1. Glare off the glass was very sharp and almost blinding.
2. The room had become so dark as to make it necessary to turn the lights on, thus defeating the purpose of the product, which was energy efficiency.
3. Interior decorators consulted had said mirror finish will only find few customers and will not have mass appeal on a blind

This invention solves the above three problems and more.

The 10 Architectural Impacts of Blinds

1. Diffused Lighting

It is not possible to overstate the importance of lighting in interior architecture. Lighting makes a difference on how the interior decoration looks; It affects the mood and psychology of occupants. It is also important from a visual comfort point of view and total lack of it is best for sleeping. Plants in the room are also affected by the amount and type of light (direct or diffused) light that come into the room.

2. Direct Lighting

There are two distinct types of light that can enter the room from outside: a. direct sunlight, b. diffused sunlight. Diffused light would be the kind of light you would get if your window was facing north (in the northern hemisphere). Direct and diffused light are very different in terms of solar heat, luminosity, and visual comfort. Direct light causes eyestrain, creates glare, heats up the room, and fades the furniture. It could however be useful for plants inside or to warm up the room in a cold day. On the other hand, diffused lighting is more tamed. All the lighting fixtures that are designed inside the home are designed in such a way to cast their light in a diffused way. Diffused light is softer.

3. Interior Aesthetics

Blinds can be wall to wall and effect the way an entire wall or walls look. Wouldn't it be great, for variety, if your blinds could change colors?

4. View

View and light control are the two most important aspects of blinds. With conventional blinds less light means less view.

5. Privacy

With conventional blinds more privacy means less view and light.

6. Darkness When Closed

Darkness has been shown to improve quality of sleep. Also total darkness may be desired while watching a computer or TV screen.

7. Acoustics

In a corner office of a high-rise building, for example, two vertical blinds can cover two entire walls. How they reflect sound waves has an impact on acoustics of the room. When the grooved surfaces are turned facing inside they act like a sound chamber, reducing echo and improving sound quality, which makes it also ideal for hi-fi systems.

8. Glare

Direct sunlight impinging on the slats is reflected into the room in form of scattered and direct light. Direct light as glare is annoying and scattered light also does cause visual discomfort to some degree.

9. Summer Energy-Efficiency

Heat flows inside and out more through windows than walls.

⅙ (one sixth) of the energy consumed in the United States is spent on cooling of the nation's buildings. The disclosed invention reduces this country's dependence on foreign energy in a substantial way.

10. Winter Energy-Efficiency

⅙ of the energy consumed in the United States is spent on heating of the nation's buildings winter.

Limitations of Today's Ordinary Blinds

There have not been any inventions with mass appeal in the blind industry since the invention of the blind. There are numerous patents for blinds but these inventions are complicated, expensive, and/or not practical.

The only variations in today's blinds are their color and their material. Otherwise, they are basically all the same. Today's blinds have the following limitations:

1. Mutually Exclusive View & Light

View and light & heat coming in are mutually exclusive. To reduce light coming in, view is sacrificed; to reduce heat coming in, view is sacrificed

2. Monotony

Are monotonous in color, they offer only one.

3. Glare

Allow glare coming inside.

4. Darkness When Fully Closed

Do not provide real darkness when they are closed.

5. No Acoustical Properties

Have no acoustic features and benefit.

6. Energy In-Efficient (Summer & Winter)

And unfortunately, with the profound effect they have on heat gain and loss, they do mostly have no energy savings features.

### OBJECT OF THE INVENTION

The object of this invention is to improve blinds in eight of the 10 architectural impacts that they have. The table below is a comparison of ordinary blinds and the disclosed invention for each ten architectural aspect of the blinds.

| | Ordinary Blinds | The Invention |
|---|---|---|
| Interior | Allows direct | Provides diffused/soft light when |
| Lighting | reflects direct | desired . . . soft and less eyestrain |
| (Diffused) | sunlight inside | and rich luminous sun without the |
| | | bright light and glare in your home |
| | | off your computer and TV screen. |
| Interior | | |
| Lighting | | |
| (Direct) | | |
| Interior | One color | Three choices . . . thus providing |
| Decoration | | variety to how your interior looks |
| View | View and light | Breaks the Paradox . . . can provide |
| | are mutually | 30% less light without any loss of |
| | exclusive. Less | view . . . for people who enjoy their |
| | light means | view. |
| | less view. | |
| Privacy | | |
| Darkness | Only 80% | 95% . . . For better sleep and less |
| When Closed | | reflection off your TV and computer |
| | | screen. |
| Acoustics | None | One surface acts as sound chamber, |
| | | the other surface has more echo . . . a |
| | | compliment to hi-fi systems. |
| Glare | Direct rays of | Zero glare or unpleasant bright light |
| | the sun are | is reflected from slats to the inside. . . |
| | reflected off | With no glare coming off in between |
| | the slats | the slats, the view of the outside is |
| | | clearer. |
| Summer | None | $15,000/Year* for ten story |
| Energy | | building. More as price of energy |
| Efficiency | | goes higher. In the 20 years life of |
| | | the blind. |
| Winter | None | Traps heat inside. Up to 5000 dollars |
| Energy | | a year. |
| Efficiency | | |

### MERITS OF THE INVENTION

A Breakthrough in Architecture

It is an ordinary blind that has been modified and now is two blinds in one. It does everything an ordinary blind does. But its slats rotate fully around their longitudinal axis and one side of the slats has a special v-groove surface that has been coated with infrared reflective material.

It is important to emphasize that this inventions is an ordinary blind that can act like a more complex blind. This way the consumer is not buying a radically new product. The consumer is buying a product they have always had that can be transformed into a more sophisticated blind. This way the product will find easier market and mass appeal acceptance.

Breaking the Light/View Paradox

The object of this invention is to introduce a new concept in architecture. The most important aspect of this invention is that it breaks a paradox.

IncrediBlind™ (the commercial trademark of this product) is two blinds in 1: With v-grooves facing down, it is an ordinary blind; with v-grooves facing up, it is the IncrediBlind.

When conventional blinds are open, they allow light into the room and provide view of the outside. When closed, they allow no light into the room and eliminate the view of the outside. The invention disclosed however, offers a 3rd option: When open, it allows very little light into the room and yet provides full view of the outside. When open, the only light allowed inside the room is indirect, diffused soft light.

With today's blinds it is impossible to reduce the light coming into the room without reducing the view of the outside. The invention makes this possible. When the v-grooves face up, IncrediBlind reduces light coming into the room without reducing the view of the outside.

Until today view and light have been mutually exclusive. The blind invention disclosed here breaks this paradox. Light entering the room is reduced by thirty percent while no view is lost.

A Breakthrough in Energy-Efficiency

The second feature of this invention is heat reflective coating. This saves energy and as such does these things:

Summer Energy Savings

Tests conducted at the Lawrence Berkeley Lab show that IncrediBlind™ reflects out up to half the sun's heat. This is equivalent to 75 watts of energy per square meter of glass (imagine turning off one 75 watt light bulb for each square meter class). For a ten-story building; six months of sunny days; and the cost of electricity of 10 cents per/kilowatt-hour, the cost saving in air conditioning electrical bill could reach $15,000 a year.

Winter Energy Savings

In winter, the IncrediBlind traps energy. When closed, the IR-reflective side faces inward to trap IR rays emanating from the warm interior surfaces such as the walls, furniture, and electrical heaters.

The cost only 30% more than an ordinary wood blind. This extra initial cost will be offset by savings on the monthly electricity bill. The payback time can be as short as only two years, after which the window continues to save money, for many more years into the future. The IncrediBlind also makes it possible to install smaller air conditioning systems. The reduced A/C cost can make the payback time zero or even negative. During times of peak electrical demand, such as a hot summer afternoon, the homeowner pays the same rate per kilowatt-hour of electricity as at other times. It costs the electric utility more, however, to produce peak load power. Some utilities provide incentives to homeowners for installing devices that reduce their peak electrical demand. Such incentives, which are provided by most utility companies, can further help offset the initial additional cost of the IncrediBlind.

In summary, the IncrediBlind is the most environmentally friendly (“green”) blind ever made. By saving energy, it offers less air and water pollution at the power plant, less depletion of (and dependence on) fossil fuels, and less emission of harmful gasses into the air.

It's About Choice

This invention is not a new product. It is an old product and acts like an ordinary and regular blind in the market today. It just will do more if desired. It is not a radically new product that may result in the “buyer's remorse” and have the buyer potentially be saying, “I should have bought a regular ordinary blind”. This blind can always be used like a regular blind. This blind is a regular blind until its slats are rotated hundred eighty degrees. Then it gives you a plethora of benefits, providing several more lighting, view, and privacy combination choices.

### DESCRIPTION OF THE INVENTION

The figures and their description show how the blinds can be made and used:

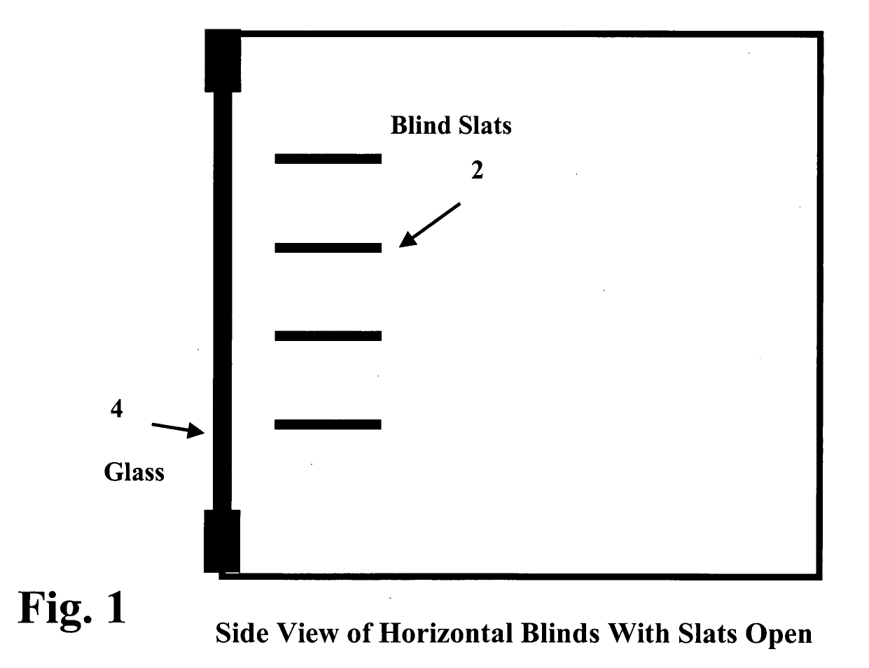

FIG. 1 Side view of blind slats 2 for a horizontal blind. Glass 4 is shown separating the inside from the outside.

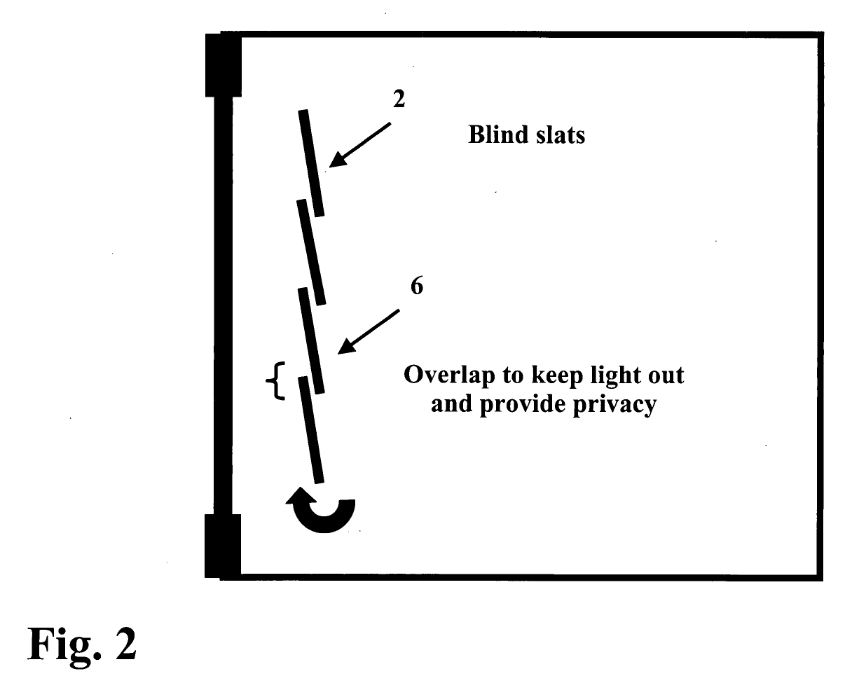

FIG. 2 Shows the overlap 6 that is created when blind slats 2 are rotated 90 degrees in clockwise fashion.

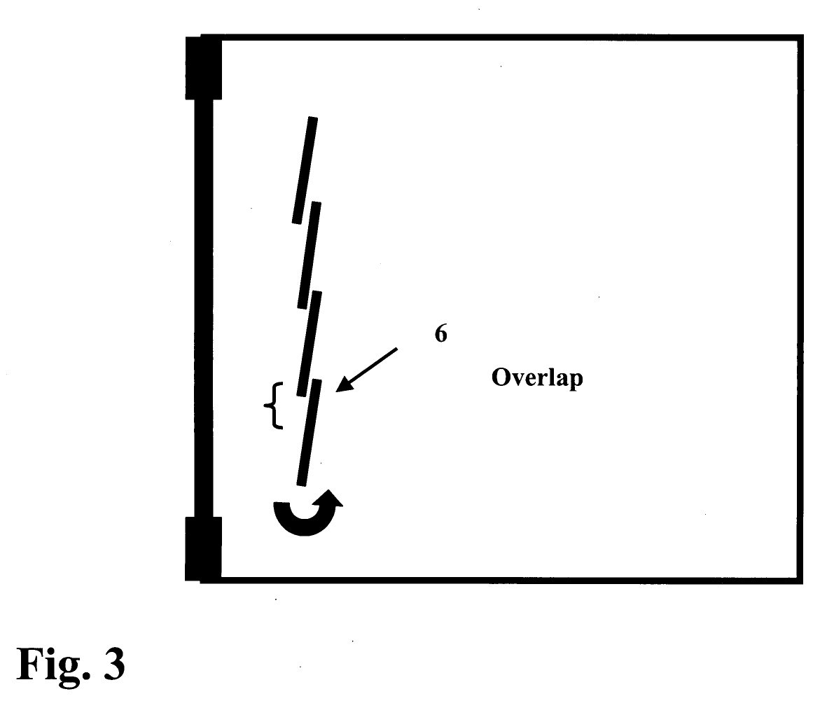

FIG. 3 Shows the overlap 6 that is created when blind slats 2 are rotated 90 degrees in counterclockwise fashion. This overlap is needed to provide privacy and darkness when the blinds are in a closed position. This overlap does not allow the slats to be rotated a more than ninety degrees.

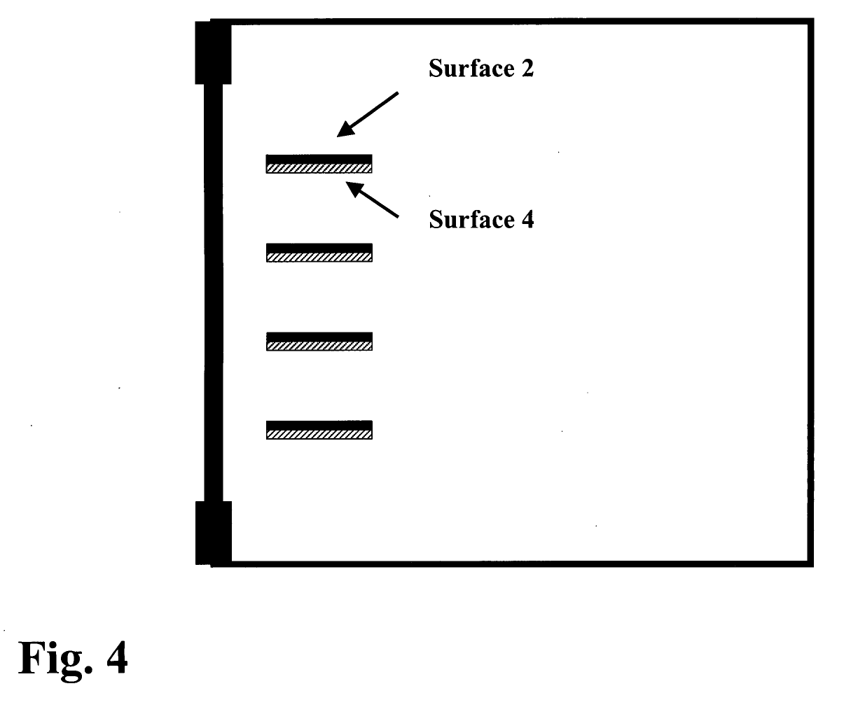

FIG. 4 Shows horizontal blind slats that have different surfaces on each face. The surface 2 and surface 4 have different optical, mechanical, acoustic properties, and/or colors and combination thereof.

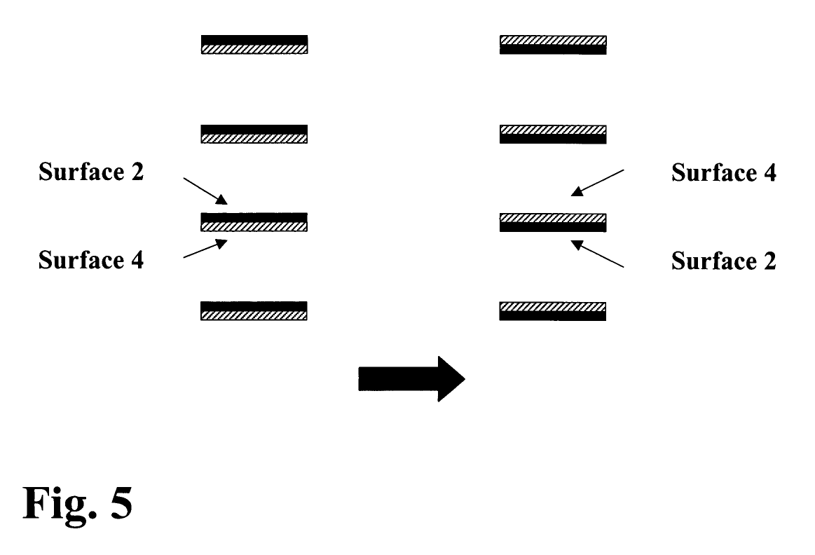

FIG. 5 The problem is how do you turn the blinds 180 degrees when they overlap?

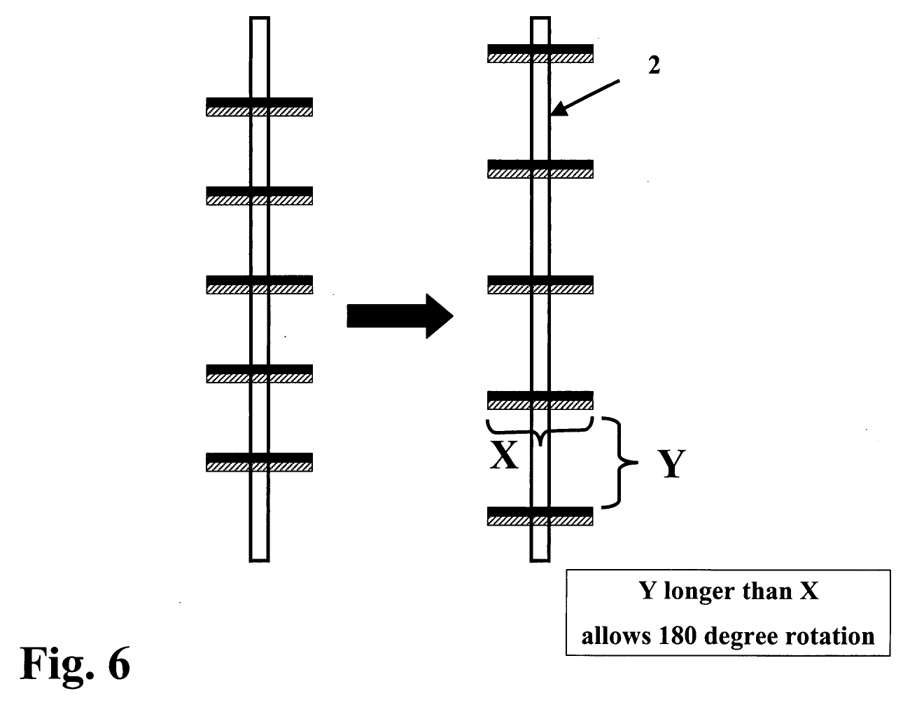

FIG. 6 Simple way is to have a railing for vertical blinds that is longer than the width of window. This railing 2 allows the slat distance to be increased to the point that they can freely rotate around their longitudinal axis 180 degrees without being stuck at the edges.

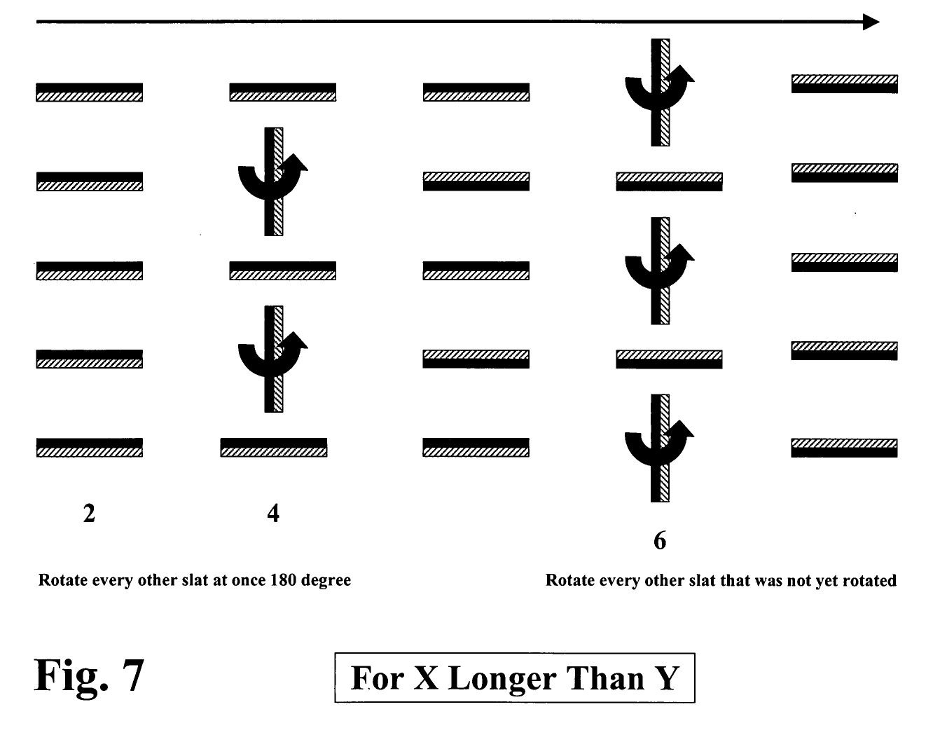

FIG. 7 Is another way the slats can be rotated despite their overlap. First open all slats full and in horizontal position (for horizontal Venetian blinds). Then rotate 180 degrees every-other-slat at once 4, and then rotate 180 degrees every-other-slats 6 not yet rotated.

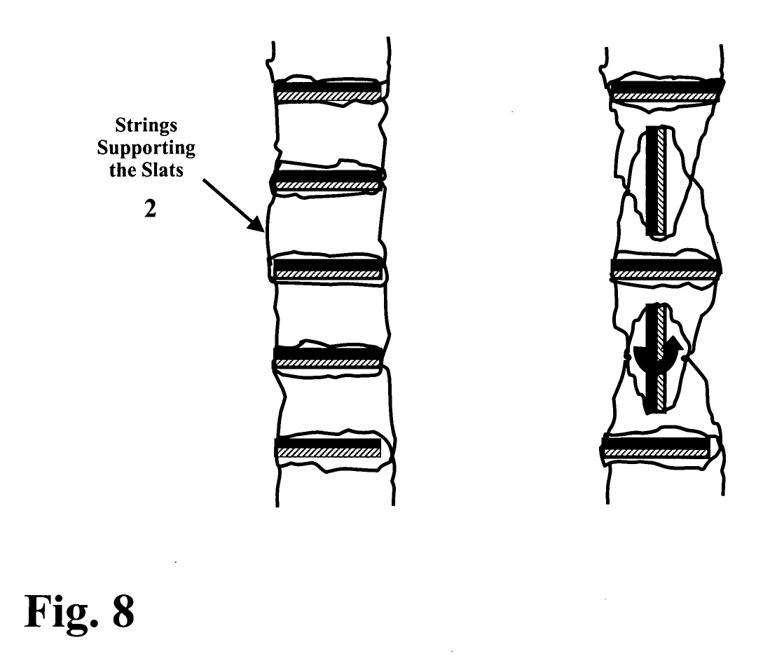

FIG. 8 Is a low cost and simple way to build such blinds. They are like blinds made today supported by strings 2. Strings allow the slats to rotate by the “every-other-slat” method.

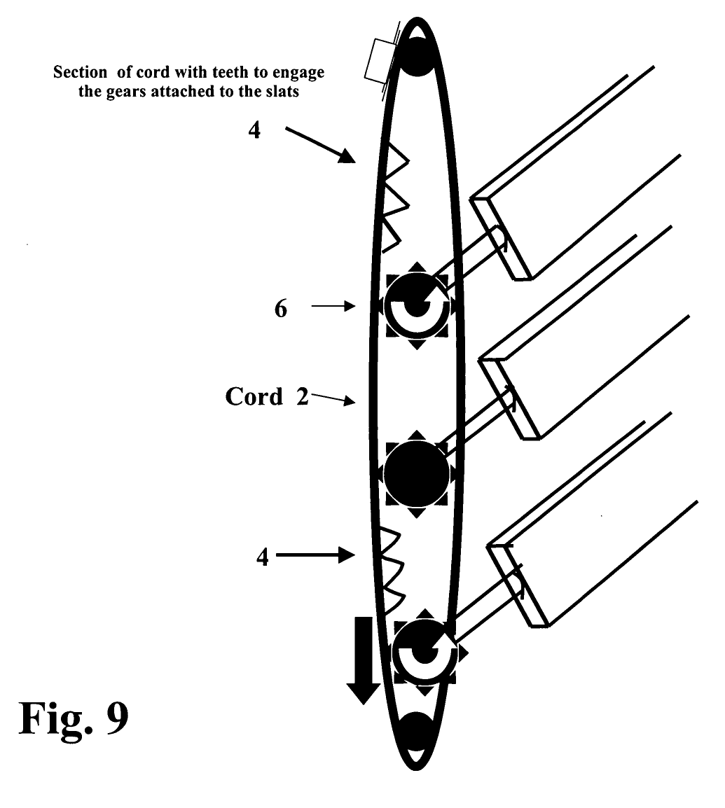

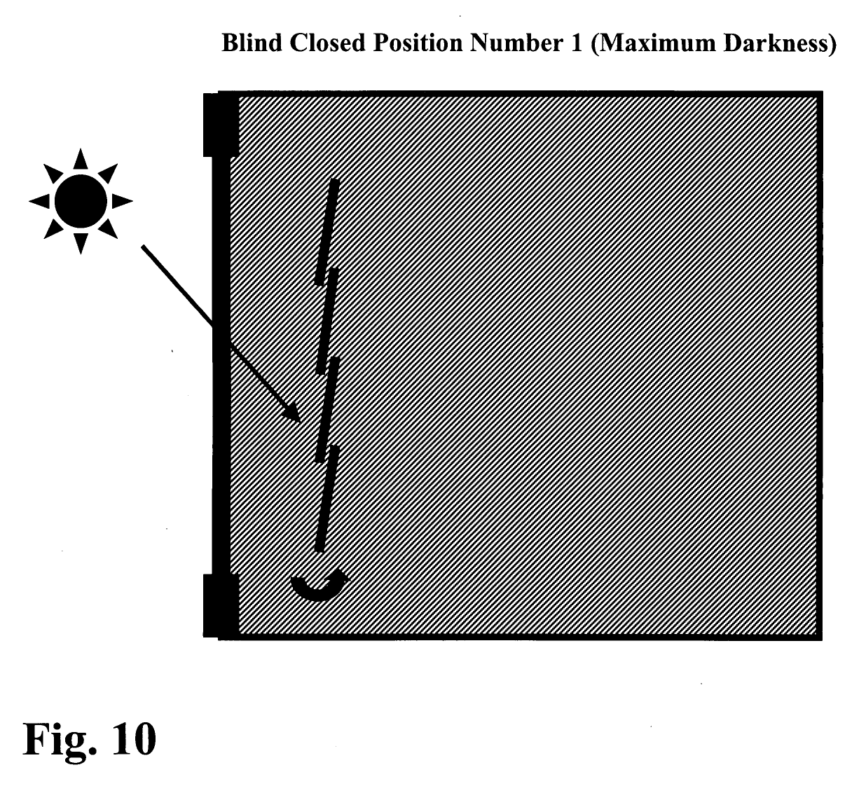

FIG. 9 Shows a chord mechanism that would have to be added to a regular blind. Cord 2 is pulled up and down and several sections on the cord have the gear teeth 4 placed on it and spaced on the cord such that to engage the gears 6 that rotate the slats.

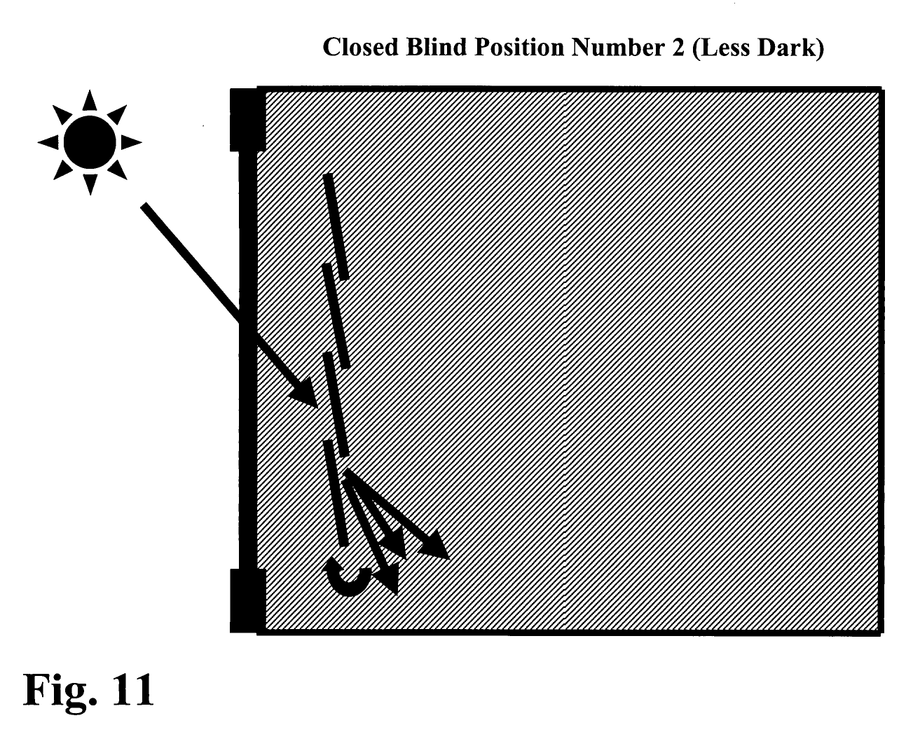

FIG. 10 Blinds can be closed in two ways: by turning them clockwise; or by turning them counterclockwise. These two closing directions provide very different lighting in the room. If the blinds are closed by slats turned in a counterclockwise position, the room will be darker than if they are turned in a clockwise position.

FIG. 11 Blinds closed and rotated in clockwise position allow slightly more light to enter the room. For a horizontal blind, when slightly opened, this position allows some rays of light to enter and light up the floor, tabletops, or plants placed near the window.

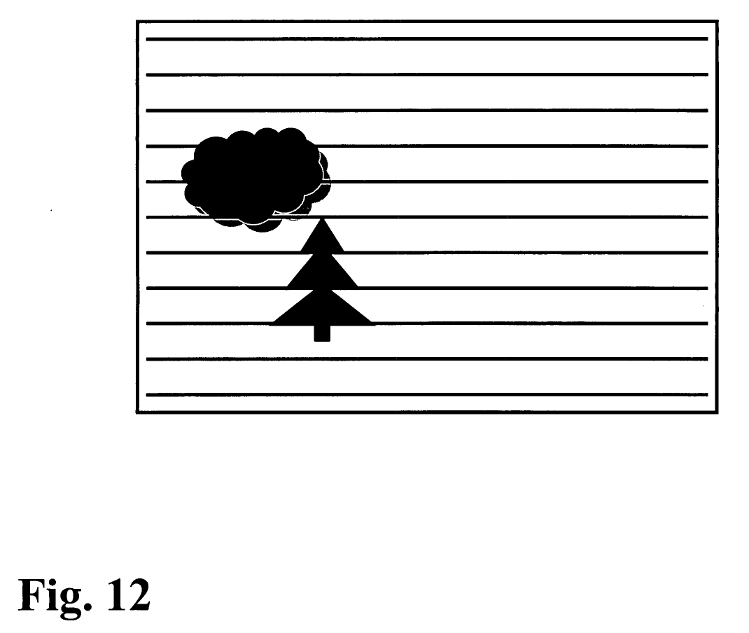

FIG. 12 is front view looking outside and how the view would be seen with the slats in fully open (horizontal) position.

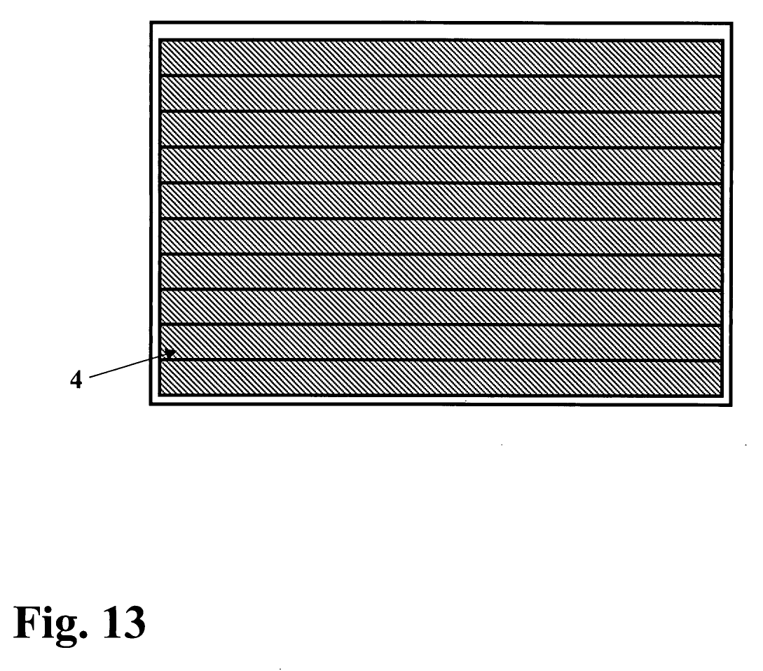

FIG. 13 Shows the blinds closed with one surface 4 facing the room interior.

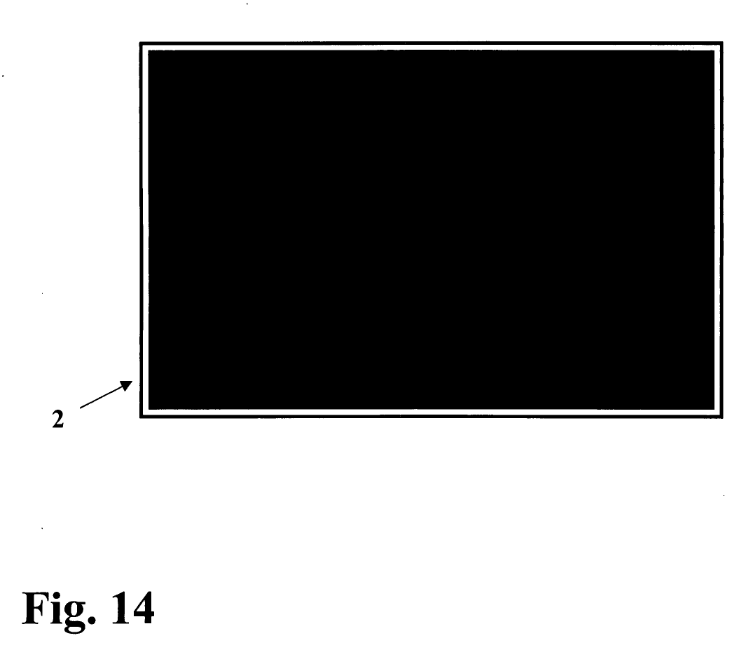

FIG. 14 Shows the other surface 2 facing the interior.

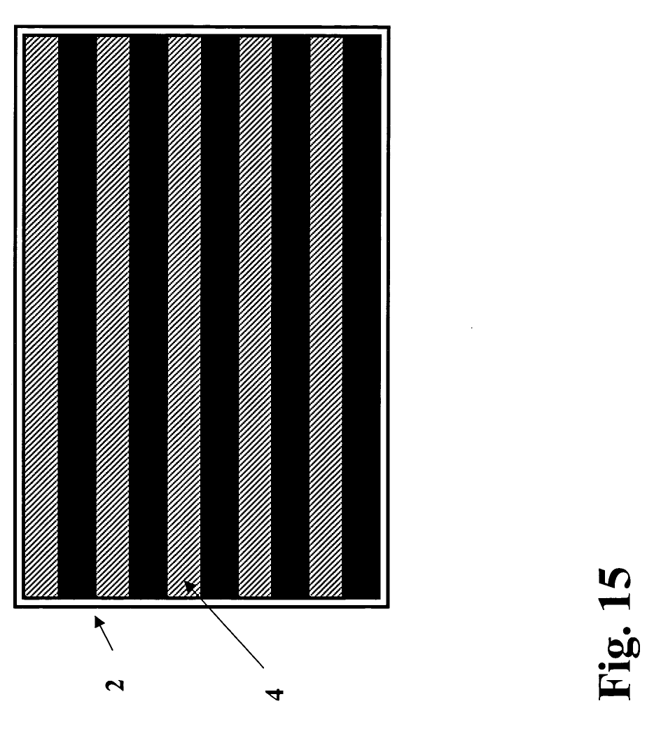

FIG. 15 Every other slat has been turned. Both surface 2 and surface 4 face the interior of room.

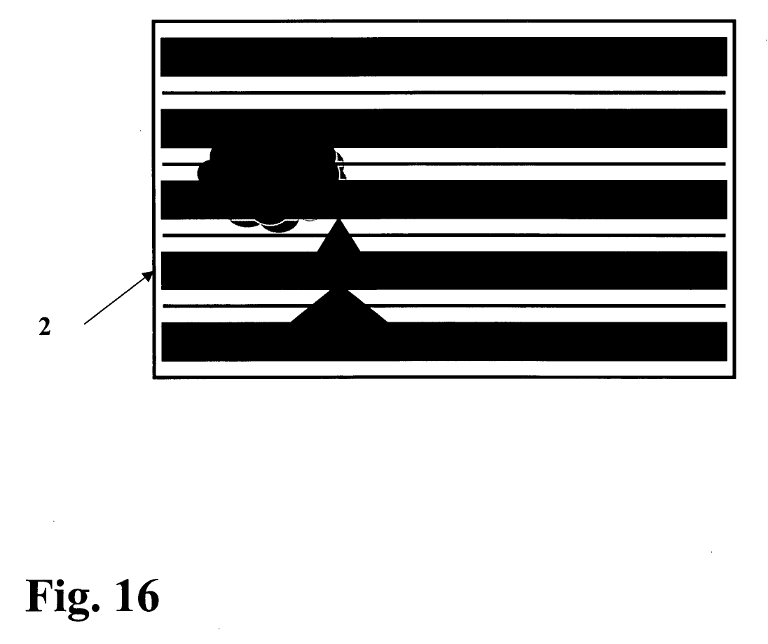

FIG. 16 The slats with surface 2 are closed and the slats with other surface are open.

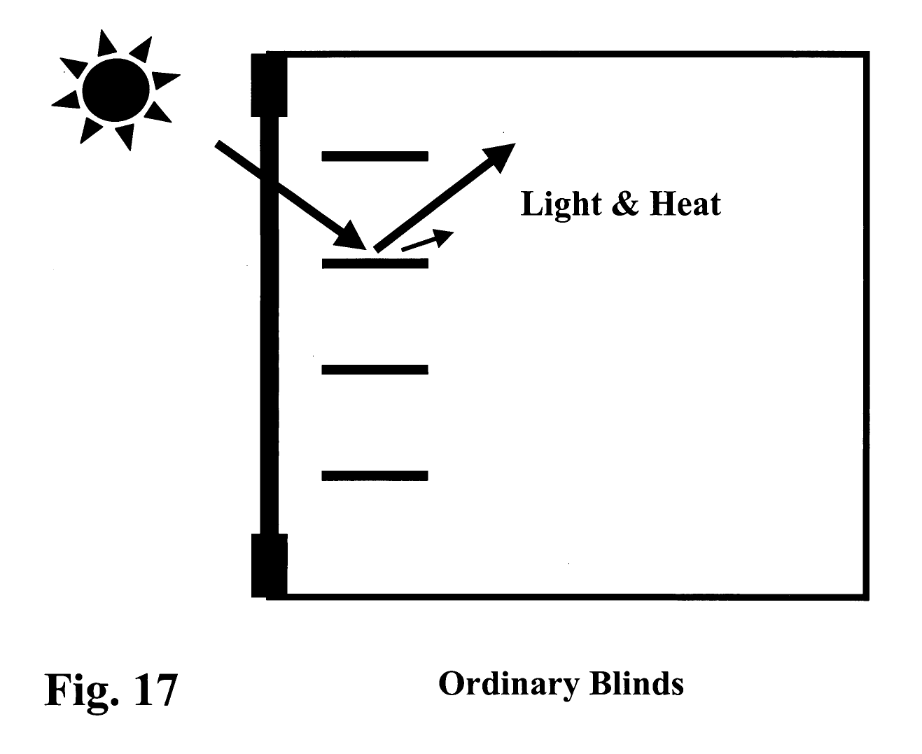

FIG. 17 Shows ordinary blinds reflecting light, heat, and glare into a room.

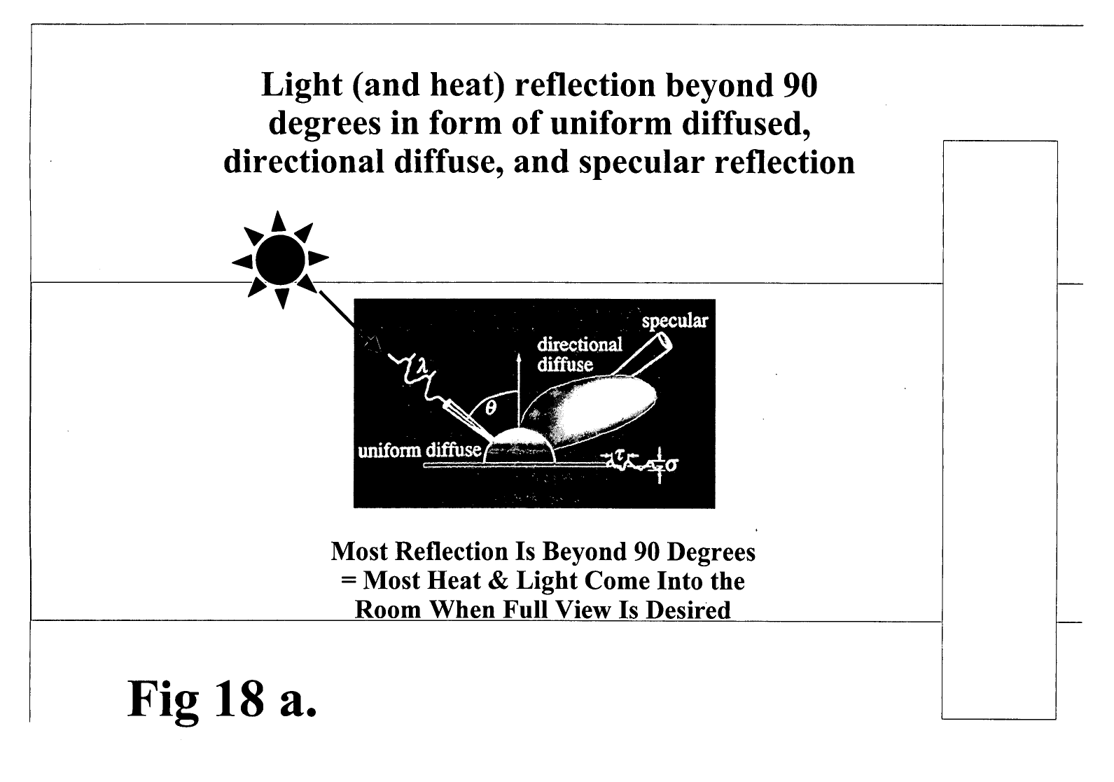

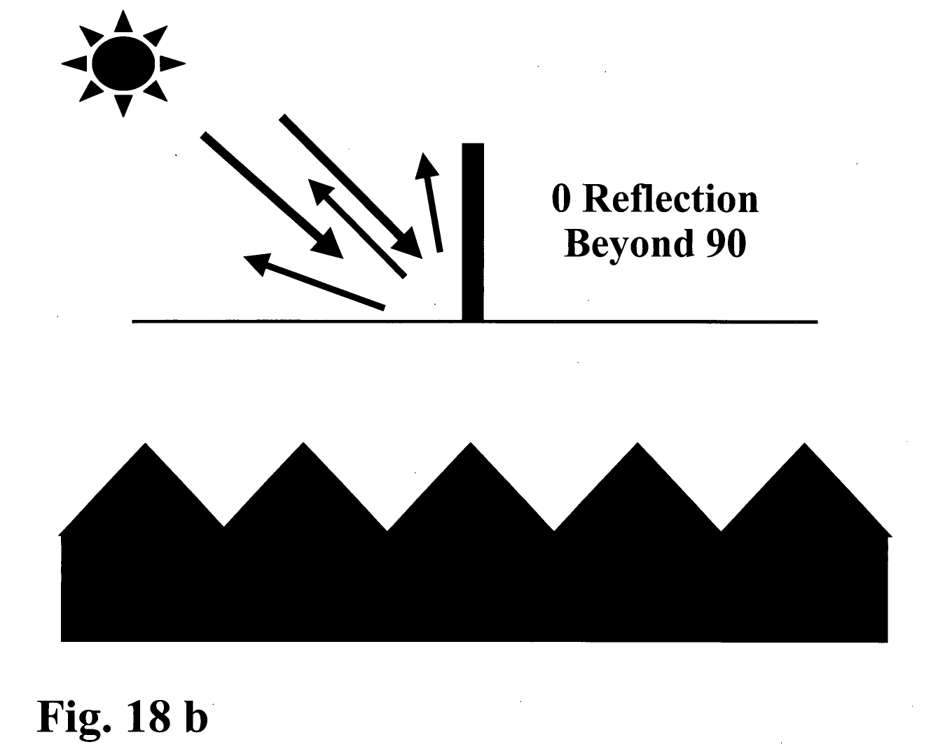

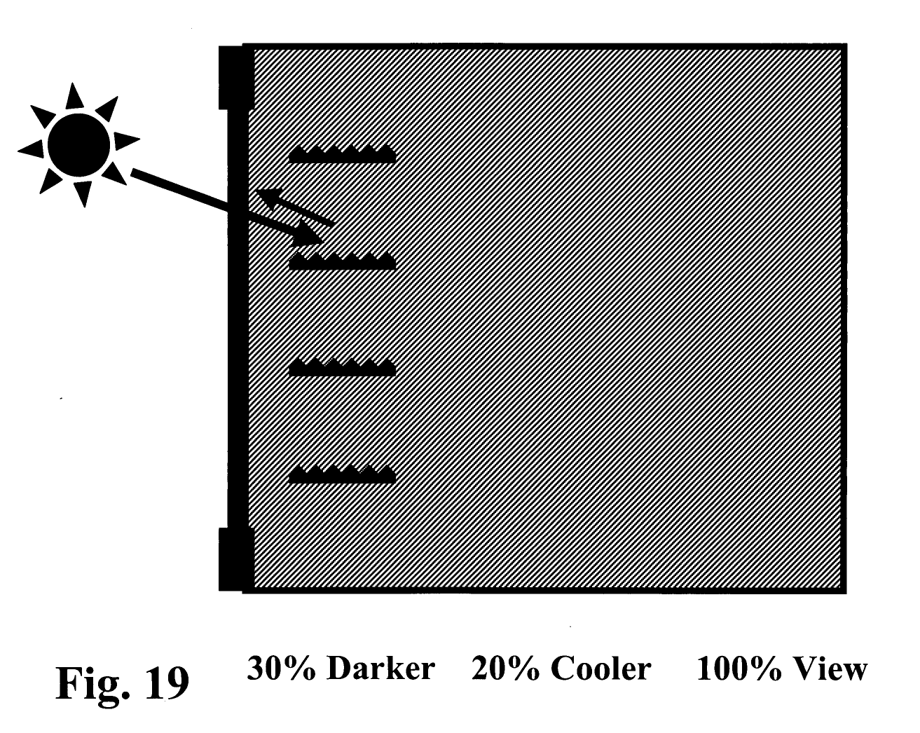

FIG. 18a. Shows the different ways light is reflected off of a surface. Reference from website: Reference: http://www.graphics.cornell.edu/research/globillum/reflmodel.html

FIG. 18b Shows how the creation of 90 degree V-grooves makes it impossible to reflect light beyond 90 degrees. The depth of grooves can be as small as 10 microns or approximately 1/10th of the thickness of the human hair. The grooves can be filled with clear plastic to make the surface of the blind even smoother.

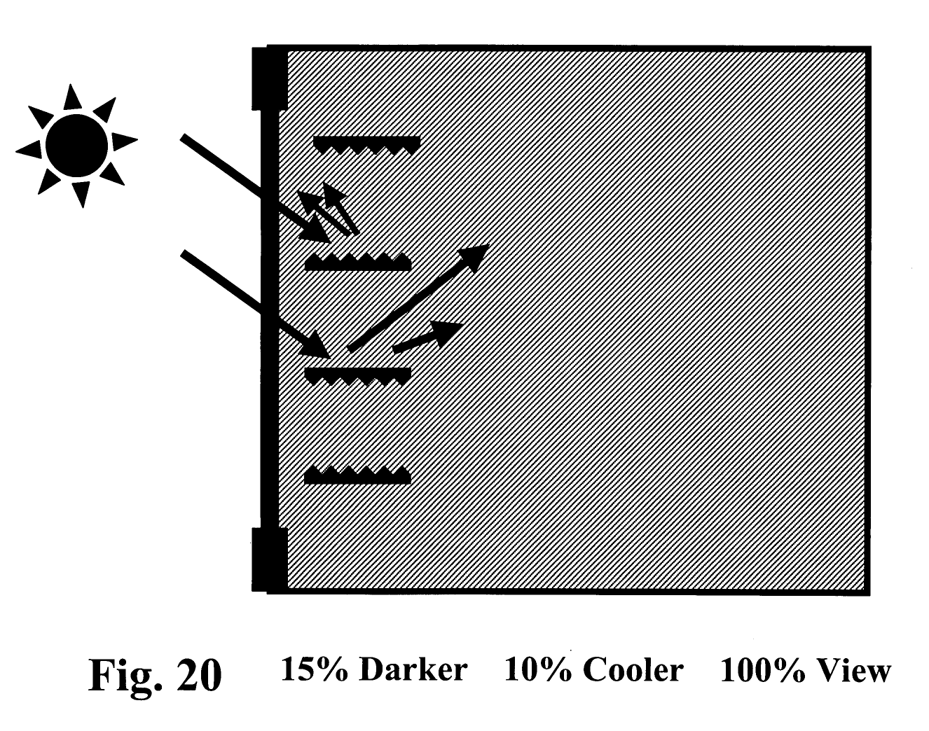

FIG. 19 Shows solar rays cannot reflect off of the slats to the inside of the room. The room is darker without losing any view. There is zero glare into the room. No glare means less eyestrain, more visual comfort, and a better view of the outside.

FIG. 20 Half the blind slats face up with grooves and the other half face down providing more lighting options.

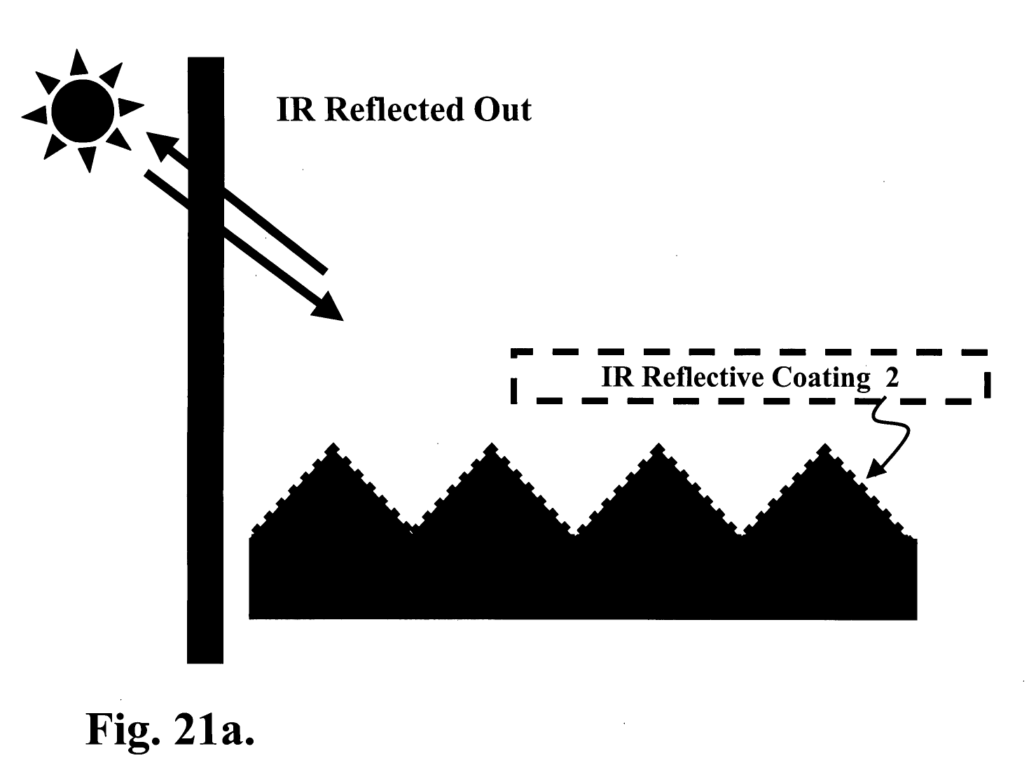

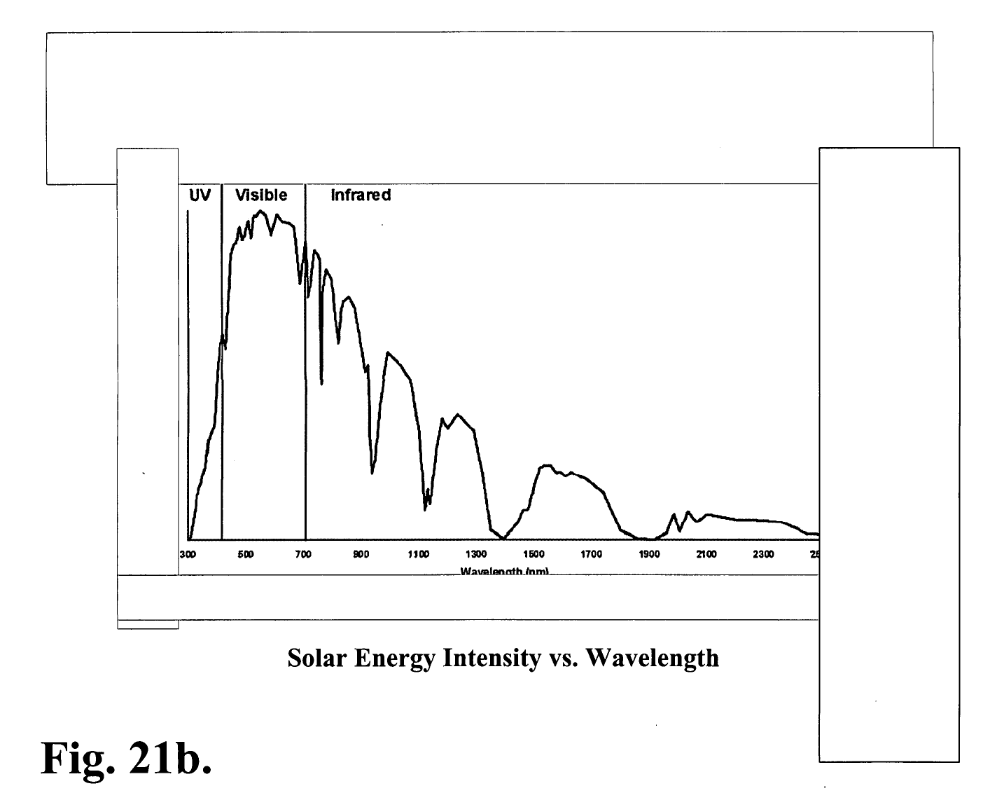

FIG. 21a. Thermal benefits of the blinds are drastically increased by addition of a solar radiation reflective coating 2 on the surface of the grooves. The solar energy is reflected to the outside without losing any view. Ideally the grooved surface must be glossy/shinny white to also reflect as much rays in the visible region of the electromagnetic radiation spectrum of the sun.

FIG. 21b Is the intensity of solar radiation vs. wavelength. The IR reflective coating reflects from 700 nm to 5000 nm. A special coating can be made to reflect part of UV and even visible region. The ideal coating on the grooves should reflect as much energy as possible from 300 nm to 5000 nm without causing glare off the surface of the glass. Thus the glass and the blind are one system and must be designed together. Objective is to minimize glare and reflection back into the room, while maximizing the solar energy reflectivity of the grooved surfaces on the slats.

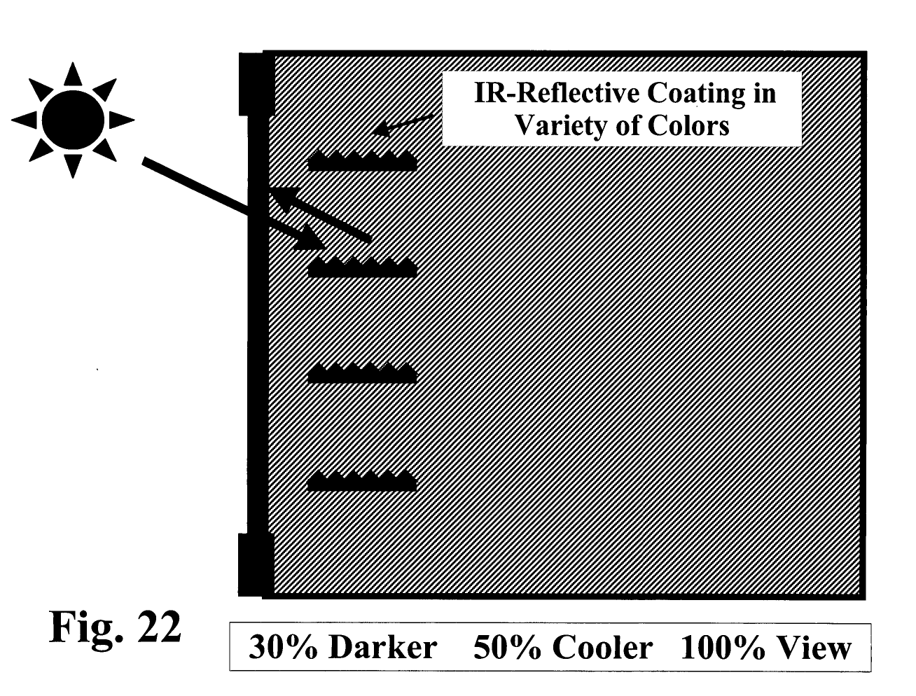

FIG. 22 Thermal benefits of the blinds are increased by addition of a solar radiation ray reflective paint or coating or pigment on the surface of the grooves. Grooves could be with coating capable of direct reflection of some wavelengths of light in the UV, visible, near-infrared, far-infrared region, and/or combination thereof.

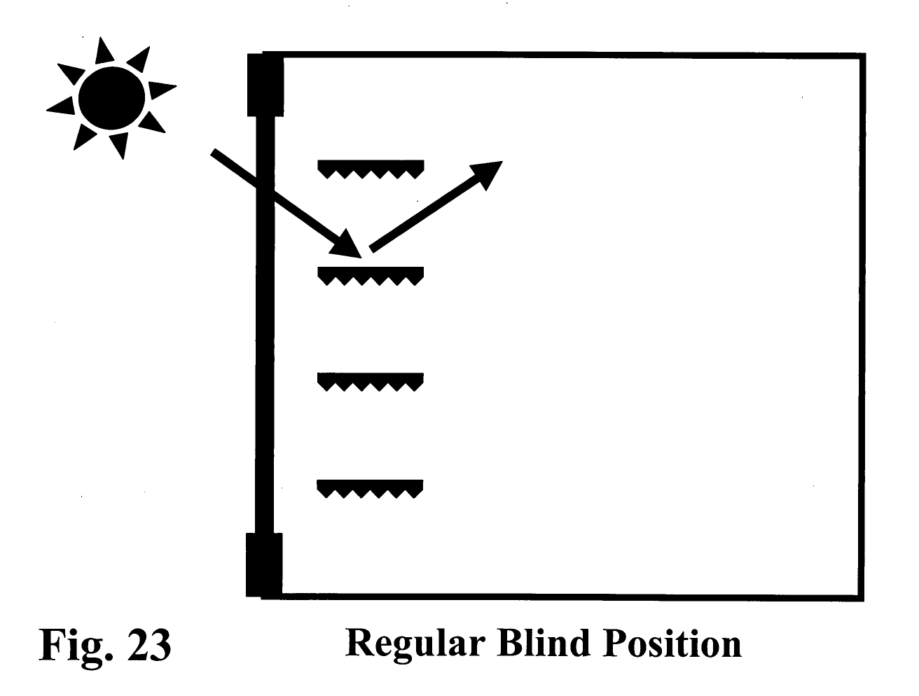

FIG. 23 The disclosed invention can be used as an ordinary blinds existing today.

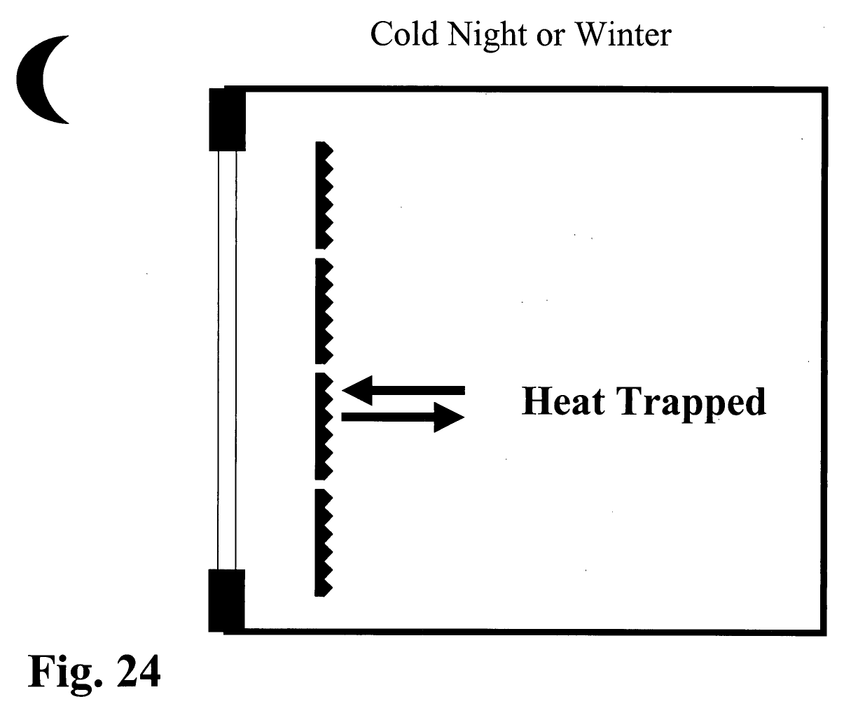

FIG. 24 If the coating on the blind slats has both near and far IR reflective coating, then it will reflect the heat that is trying to escape outside, back into the room.

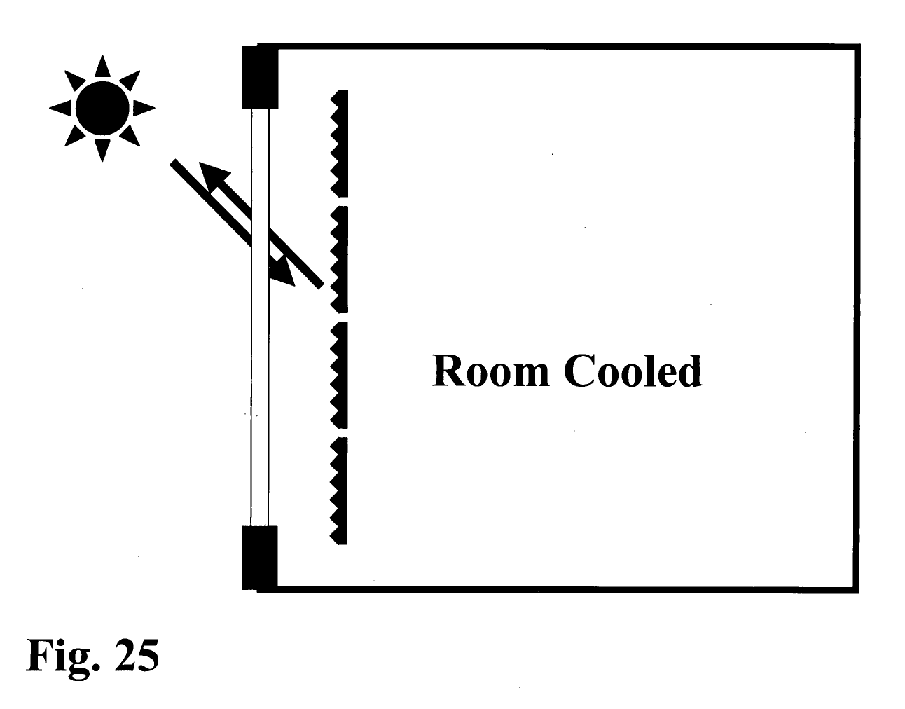

FIG. 25 Shows for horizontal blinds how glare is kept away from the street for better external aesthetics.

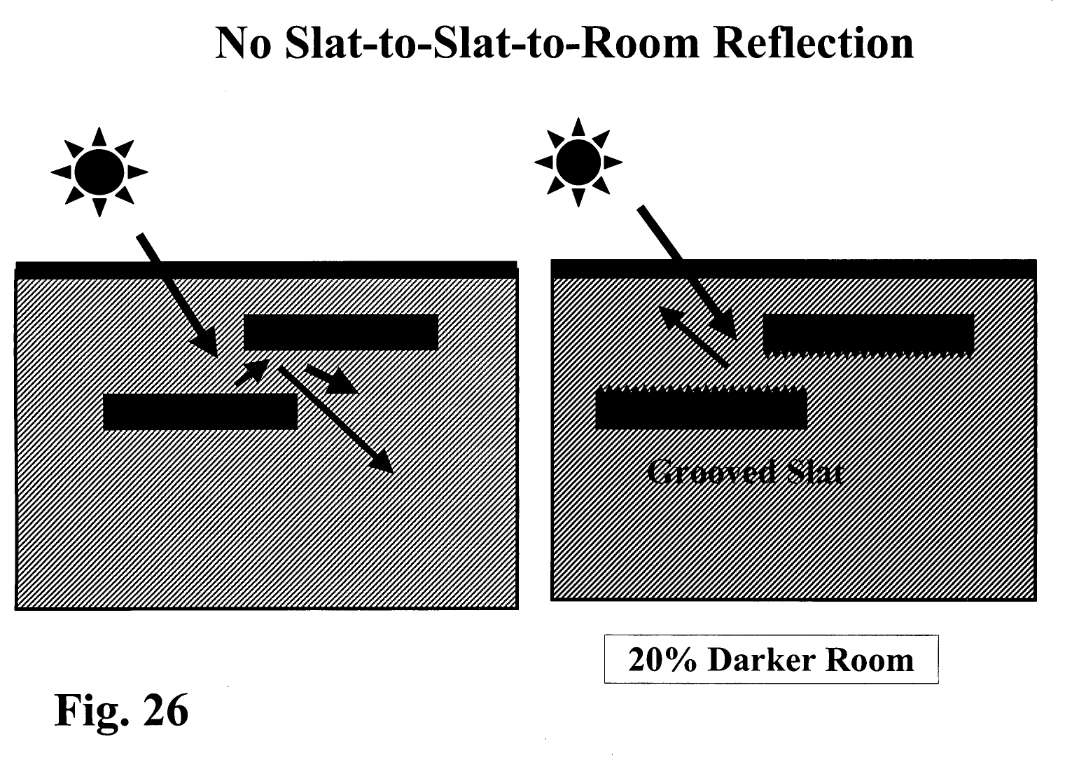

FIG. 26 Slat-to-slat-to-room reflection prevents total darkness when the blinds are closed.

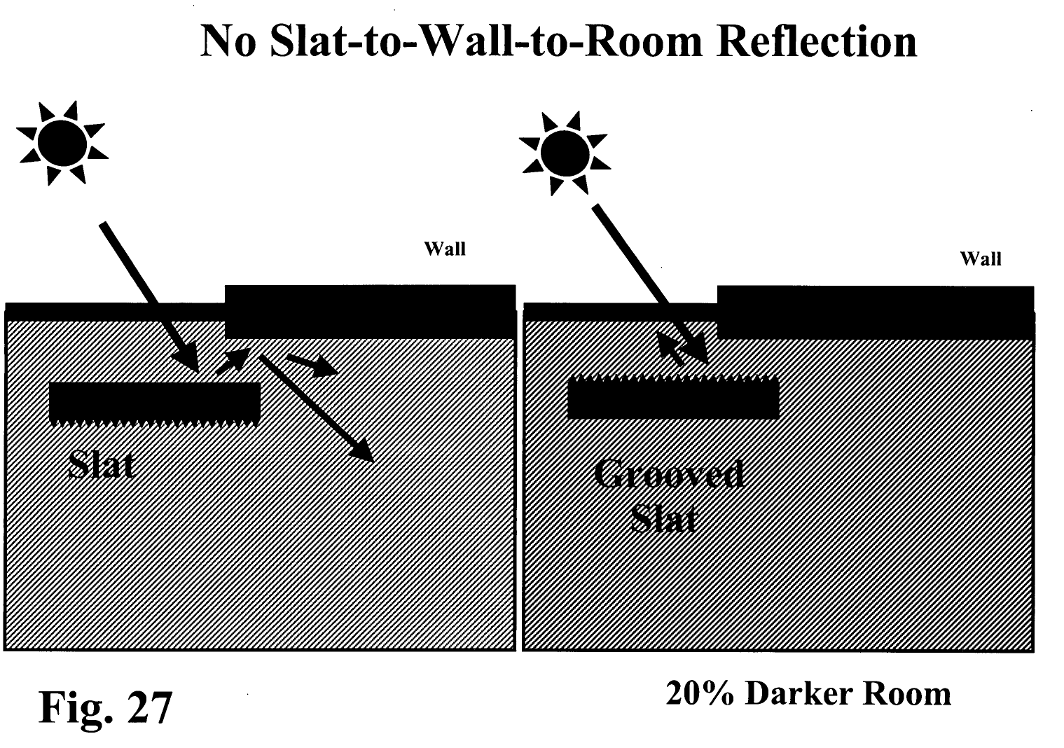

FIG. 27 Slat-to-wall-to-room reflection prevents total darkness when the blinds are closed

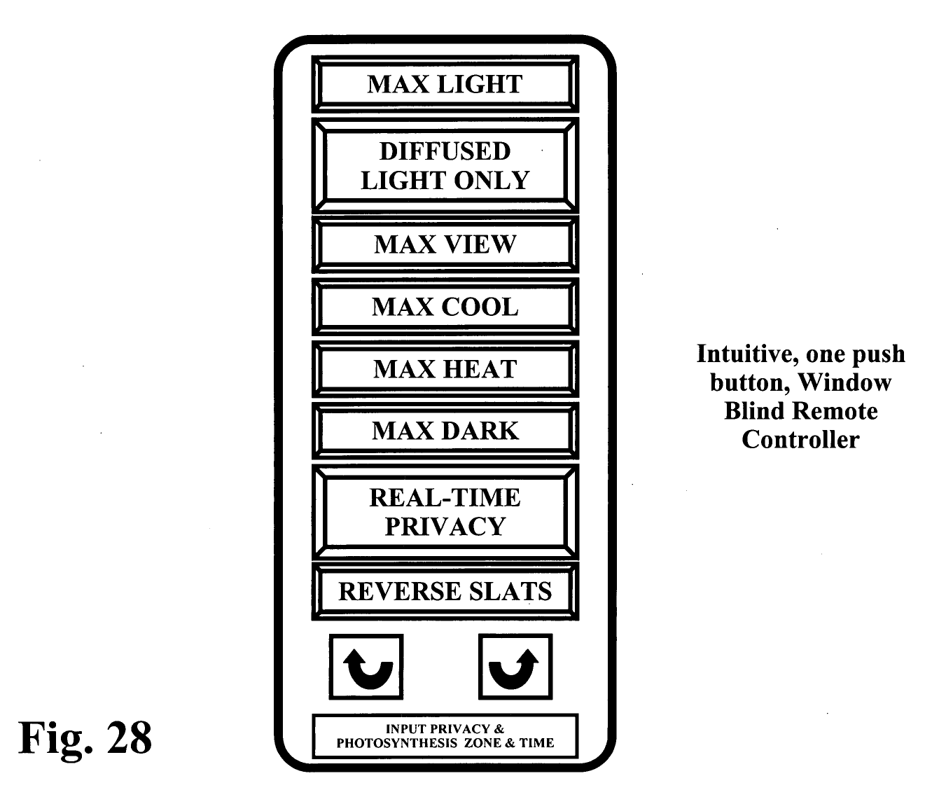

FIG. 28 Shows an intuitive blind remote controller. This system is needed since the invention disclosed here provides many options for how it can be used. So the commands are result oriented. The customer just inputs that he wants the least amount of heat to come in and the computer knowing the GPS information and orientation from a compass knows what is the optimum direction of rotation and the angle of rotation of blinds should be and adjusts the blinds accordingly. The system can be set to track the sun all day or it can simply take one result-oriented command. E.g., if the button maximum darkness is pushed, it takes into account the position of the sun based on time of day and rotates the slats as to provide maximum darkness. Also if a button is pushed that is marked, “MAXIMUM AIRFLOW”, the blinds automatically come to the maximum open position without the user having to hold the button down for few seconds. This is like controls on a electric window of a car that you can just with one push of a button say close and it closes all the way without you having to hold the close window button down for few seconds.

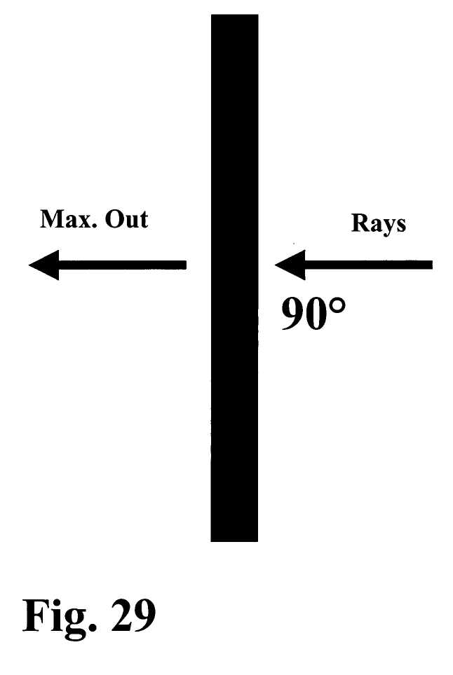

FIG. 29 In order to save maximum energy, blind slats must have coordinated movement with the movement of the sun. Based on knowledge of position of the sun and orientation of window, the computer, keeps the slat at such angle to reflect out solar radiation at a ninety-degree angle to the glass. This way reflection of solar energy off the two surfaces of the glass into the room is minimized.

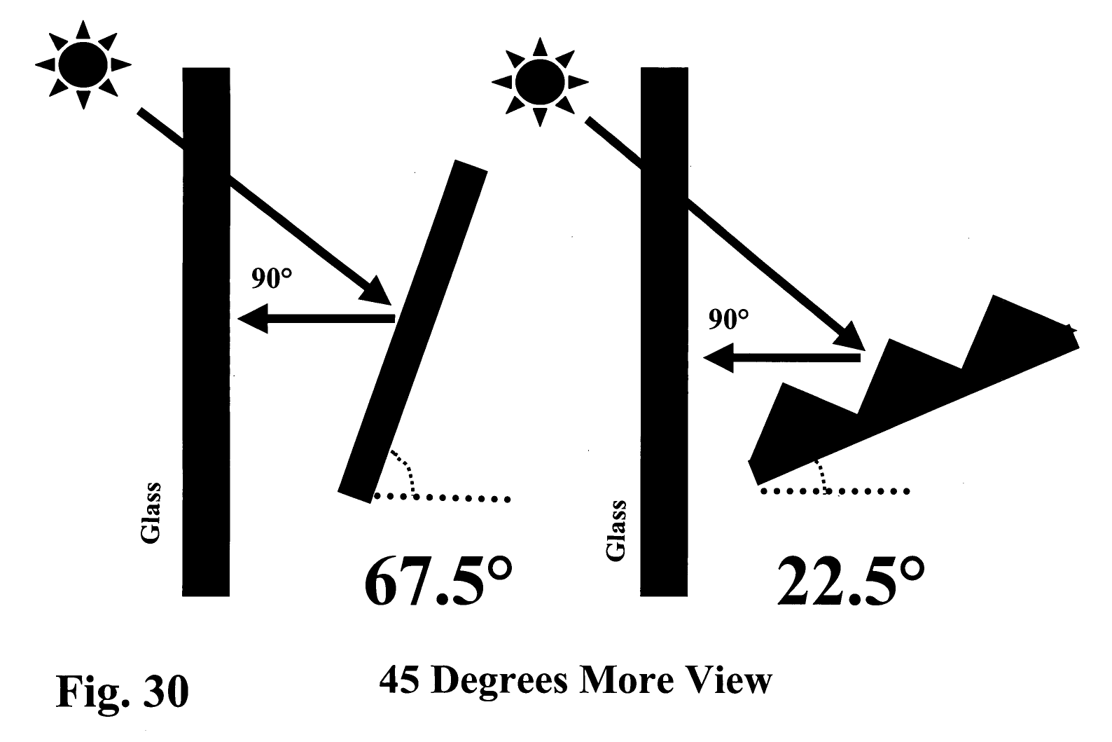

FIG. 30 Shows the V-groove side can provide forty-five degrees more view for the same amount of energy-efficiency.

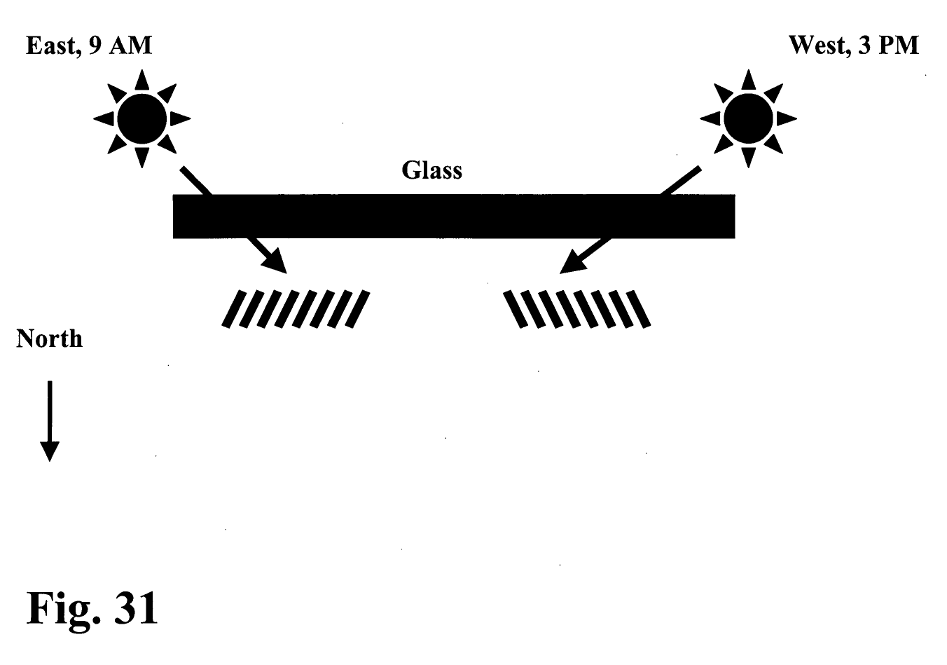

FIG. 31 Knowledge of the position of the sun is needed for optimum lighting. As the sun moves from east to west for example, the angle of the vertical blinds must change accordingly to prevent direct sunlight in and yet to provide soft diffused lighting. Position of the sun must also be known for closed position that provides maximum darkness. The direction of rotation of blinds is the opposite in early day than late afternoon to keep the room darkest (when using vertical blinds and a south facing window in the northern hemisphere).

Light is reflected off a surface by three ways: Uniform diffuse, Directional diffuse, and specular. The ideal grooved surface is glossy/shinny smooth and smooth. This way it reflects maximum of energy in the visible region, but in a diffused way, thus creating minimal glare from the surface of the glass comes back to room. The blind can be of any color, but preferably glossy to have maximum directional diffused reflection at its surface.

### PRIOR ART

Curshod's U.S. Pat. No. 5,204,777USA

EP0303107

FR2574469

U.S. Pat. No. 5,204,777USA

DE 19700111

AU4000185

Also all worldwide patents that reference or are referenced by above patents.

### OTHER EMBODIMENTS

1. Overlapping slats can be rotated a full one hundred eighty degrees if every other slats rotates in opposite direction. That is the odd number slats turn counterclockwise and the even number slats turn clockwise. This way all the blind slats turn one hundred eighty degrees at the same time with one action.

2. The blinds disclosed in this document can be used for skylights as well. They can also be shutters and can be either horizontal Venetian blinds or vertical blinds.

3. Instead of IR reflected, the surface can be designed such that to directly reflect our selected regions of solar energy radiation spectrum.

4. Instead of v-grooves, retro reflective coating can be used but it would not be as effective. Retro reflective could be used either on a flat surface or on the v-grooves.

5. A real-time privacy feature can be added to the computer controlled window blinds. This is specially useful for vertical blinds. The blind senses where you are in a room, say by computer vision and then turns the slat in such a way that no one from the outside can see you inside. This way for example if you do not have any clothes on, you do not have to close all the slats to allow you to freely move in the room. The system can be taught to know where the privacy zones are and what zones expose the interior to external viewing.

6. A real-time view feature could be such that the blind slat angles of a vertical blind change as the occupant moves about in the room. The slats rotate to allow her or him maximum view of the outside.

7. The two surfaces of blinds are such that when they are all rotated in one direction a big image of a cartoon character for kids room is shown on one surface and when they are all turned the other ay a different character spanning plurality of slats appears.

8. the surface of the grooves if black and coated with IR will reduce glare back into the room. Ideally the surface must have reflectivity of the IR region in a specular way.

9. The v-groove surface paint/coating/pigment variations: Ideally it should be such that it reflects IR energy in a specular way (to reflect outward maximum energy) and it reflects visible ray energy in a diffused (either direct or uniform) way. This way the glare from the surface of the glass back into the room will be minimized. It should be noted that the original test done at the LBL used a shiny surface that was not designed for maximum IR specular reflectivity. As such it reflected only half the heat of the sun. If the surface specularly reflected both visible and IR the savings could have been as much as 100 Watts per square meter of glass. If a computer control blind is used that controls angle of slat to reflect out the solar energy at ninety degree incident angle to the glass, then savings could be as much as 120 Watts. Furthermore if the glass is designed to minimize glare, there could be another 10% or about 10 more watts at about 125 average savings for a building. This is the ideal energy efficiency of these blinds.

10. One of the inputs to the computer for its automatic operation, is the location of plants and what type of sunlight (diffused or direct) it should receive and how often.

11. The surface of the blind can have other features besides triangular grooves to make it acoustically beneficial and give it sound dampening features.

12. One method of turning blinds that overlap at the long edge when in closed position is this: simultaneously rotate every other slat (for example odd number slats) clockwise while at the same time turning the other slats (the even numbered slats) counter clock wise. This way the edge will not get stuck together and the blind slats are free to rotate freely.

1. A blind comprising:
(a) A plurality of slats.
(b) Said slats having faces with different properties.
(c) Means for rotating said slats at least 180 degrees around their longitudinal axis.
whereby increased options are provided to the user for lighting, thermal, and aesthetics control of a room.

2. A blind as in claim 1, wherein said slats have on one face triangular grooves on the surface.

3. A blind as in claim 2, wherein said grooves are the shape of an isosceles right triangle.

4. A blind as in claim 3, further comprising of a solar ray reflective paint on the surface of said grooves.

5. A blind as in claim 4, wherein said solar rays are mostly infrared.

6. A blind comprising:
(d) A plurality of slats.
(e) Said slats overlap at the long edge when said slats are in closed position.
(f) Said slats having faces with different physical or optical properties.
(g) Means for simultaneously rotating all the slats at least one hundred eight degrees.
